(19) United States
(12) Patent Application Publication
(10) Pub. No.: US 2025/0386837 A1
(43) Pub. Date: Dec. 25, 2025

(54) SOYBEAN SAPONIN-ENRICHED CHOCOLATES

(71) Applicant: FUJI OIL CO., LTD., Osaka (JP)

(72) Inventors: Satoshi OTA, Ibaraki (JP); Keita HIRANO, Ibaraki (JP); Nobuhiko TACHIBANA, Ibaraki (JP)

(73) Assignee: FUJI OIL CO., LTD., Osaka (JP)

(21) Appl. No.: 19/230,117

(22) Filed: Jun. 6, 2025

(30) Foreign Application Priority Data
Jun. 25, 2024 (JP) 2024-101677

(51) Int. Cl. A23G 1/48; A23G 1/44; A23J 3/16

(52) U.S. Cl. CPC A23G 1/48; A23G 1/44; A23J 3/16

(57) ABSTRACT

Problem:

Soybean saponins have been reported to possess various physiological activities, but their content in natural products is low, and blending into other materials is difficult in consideration of flavor and physical properties. Furthermore, concentrated saponins significantly impair flavor. The objective of the present invention is to find a material that contains soybean-derived saponins at a high content without unpleasant bitterness or astringency, and to produce saponin-enriched chocolates using this material.

Resolution:

It has been found that a poorly soluble soybean protein material, which is unhydrolyzed residue generated by the enzymatic hydrolysis of a soybean protein raw material, contains saponins at a high content and does not possess unpleasant bitterness or astringency. By blending this poorly soluble soybean protein material into chocolate, the target amount of saponins can be included without affecting the flavor and texture.

### CROSS-REFERENCE TO RELATED APPLICATION

This application claims the priority benefit of Japan application serial no. 2024-101677, filed on Jun. 25, 2024. The entirety of the above-mentioned patent application is hereby incorporated by reference herein and made a part of this specification.

### TECHNICAL FIELD

The present invention relates to soybean saponin-enriched chocolates and a method for producing the same.

### BACKGROUND ART

Saponins are a generic term for compounds in which sapogenin and sugar are linked via an O-glycosidic bond. Sapogenins are contained in many plants and are often found in roots, stems, leaves, or the like. They are known to be particularly abundant in legumes. Approximately 50 or more saponins have been found in soybeans, and they are broadly classified into group A saponins and DDMP saponins, based primarily on the structural differences in the non-sugar part (referred to as aglycone) (Non-Patent Literature 1).

Group A saponins are referred to as bisdesmosidic saponins, which have soyasapogenol A as an aglycon and have sugar chains linked to the hydroxyl groups at the C-3 and C-22 positions, and are main saponin components detected in soybean seed hypocotyls (Non-Patent Literature 1). Furthermore, DDMP saponins have an aglycone structure with the hydroxyl group at the C-2 position of DDMP (2,3-dihydro-2,5-dihydroxy-6-methyl-4H-pyran-4-one) linked to the hydroxyl group at the C-22 position of soyasapogenol B, and are monodesmosidic saponins in which a sugar chain is glycosidically linked to the hydroxyl group at the C-3 position of the soyasapogenol B residue (Non-Patent Literature 1).

Soybean saponins have been reported to possess various physiological activities (Non-Patent Literature 1). For example, in terms of the anti-hyperlipidemic effect, it has been reported that saponins bind to sterols and bile acids in the intestines, thereby inhibiting their absorption. In addition, there are also reported cases on the inhibition of colorectal cancer cell proliferation, and in vitro studies have found that the cycle of cancer cell division is delayed in human colon cancer cell models. Regarding serum lipids such as cholesterol, it has been reported that intake of 200 mg of saponins per day by humans leads to improvement (Non-patent Literature 2).

Methods for ingesting soybean saponins include ingesting them from soybean foods or extracting them from soybean hypocotyls at a high concentration and ingesting the concentrated extracts. The content of soybean saponins in soybean food materials is, for example, approximately 0.35 mass % in Koya-tofu, and about 0.4 mass % in Yuba, which contains the highest amount (Non-Patent Literature 2). In the case of a soybean protein isolate, soybean saponins may be contained up to 1 mass % in some cases. On the other hand, for extraction of soybean saponins, most of them are generally extracted together with soybean isoflavones from soybean hypocotyls using hydrous ethanol. For example, Patent Document 1 discloses a method for producing a composition with a high content of sapogenin, a constituent of saponins, using a lower alcohol. Furthermore, alcohol is also used in the method for producing soybean saponins shown in Patent Document 2.

Chocolates represented by chocolate are widely consumed worldwide due to their favorable flavor. They also excel in masking other off-flavors, and many chocolates containing various physiologically functional substances are available.

### CITATION LIST

### Patent Document

Patent Document 1: JP 5597136 B
Patent Document 2: JP H4-36242 A

### Non-Patent Literature

[Non-Patent Literature 1] Science Forum, edited by Keisuke Kitamura, “Daizu No Subete (All About Soybeans)” Chapter 4, Section 8, part 1, Soybean Saponins (Tomoharu Tsukamoto)
[Non-Patent Literature 2] Kagaku to Seibutsu (chemistry and biology), 1983, Vol. 21, No. 4, 224 to 232

### SUMMARY OF INVENTION

### Technical Problem

As mentioned above, chocolate has a high masking effect on other off-flavors. When it is intended to blend 200 mg of saponins into a commonly available 60 g chocolate bar, 20 g of soybean protein isolate containing 1 mass % of saponins is required, which significantly impairs the flavor and texture when blended into 60 g of chocolate. The same applies to traditional foods such as tofu and Yuba. There is a need for a material with a high concentration of saponins that hardly affects the flavor and texture even when added to chocolate or the like. On the other hand, soybean saponins separated and purified using alcohol or the like involve complex and costly steps, and develop unpleasant bitterness and astringency even when used in small amounts.

An objective of the present invention is to find a material that has a high content of soybean-derived saponins without unpleasant bitterness or astringency, and to produce saponin-enriched chocolates using this material.

### Solution to Problem

In the course of extensive studies, the present inventors found that a poorly soluble soybean protein material, which is unhydrolyzed residue generated by enzymatic hydrolysis of a soybean protein raw material, contains saponins at a high content and does not possess unpleasant bitterness or astringency. The present inventors proved that by blending this poorly soluble soybean protein material into chocolate, the target amount of saponins is included without affecting the flavor and texture, thereby bringing the present invention to completion.

That is, the present invention relates to the following:
(1) Chocolates characterized by containing from 7 to 20 mass % of a poorly soluble soybean protein material.
(2) The chocolates according to (1), wherein the poorly soluble soybean protein material is unhydrolyzed residue generated by enzymatic hydrolysis of a soybean protein raw material.
(3) The chocolates according to (1) or (2), wherein the poorly soluble soybean protein material contains 2.5 mass % or more of soybean saponins on a dry matter basis and has an NSI of 10 to 60%.
(4) A method for producing chocolates, the method including the following steps (A) to (C):
(A) enzymatically hydrolyzing a soybean protein raw material and collecting generated unhydrolyzed residue;
(B) drying the collected fraction to obtain a poorly soluble soybean protein material; and
(C) preparing a chocolate dough containing the poorly soluble soybean protein material, optionally molding the chocolate dough, and then solidifying the molded chocolate dough.
(5) The method for producing chocolates according to (4), including adding the poorly soluble soybean protein material such that a content of the poorly soluble soybean protein material in the dough is from 7 to 20 mass %.
(6) A method for producing a food material for supplying saponins, the method including the following steps (A) and (B):
(A) enzymatically hydrolyzing a soybean protein raw material and collecting generated unhydrolyzed residue; and
(B) drying the collected fraction to obtain a poorly soluble soybean protein material, which is a food material for supplying saponins.

### Advantageous Effects of Invention

According to the present invention, saponin-enriched food materials, which contain a large amount of soybean saponins, and saponin-enriched chocolates can be easily obtained. The obtained saponin-enriched food materials and saponin-enriched chocolates have a preferred flavor without off-flavors derived from soybean protein materials or bitterness derived from saponins.

### Chocolates

The chocolates of the present invention are foods in which fats and/or oils form a continuous phase, and use a raw material derived from cacao. An example includes chocolates complying with the “Fair Competition Code and Enforcement Rules for Labeling of Chocolates” stipulated by the Japan Fair Trade Council of Chocolate Industry. These are general terms for chocolate-based foods such as chocolate, quasi-chocolate, chocolate confectionery, quasi-chocolate confectionery, chocolate processed products, etc., preferably referring to those with a moisture content of 3 mass % or less. Chocolates obtained by blending auxiliary ingredients such as sugars, milk powders, cacao raw materials (cacao mass, cocoa, cocoa butter), fruit juice powders, fruit powders, flavoring agents, emulsifiers, fragrances, and colorants, in certain proportions may also be included as needed.

It should be noted that the flavors of the chocolates naturally include sweet chocolates whose main components are cacao raw materials and sugars; milk chocolates and white chocolates which additionally include milk powders as main components; and flavored varieties such as coffee flavor, caramel flavor, matcha flavor, fruit flavor, vegetable flavor, and salty flavor.

### Poorly Soluble Soybean Protein Material

The poorly soluble soybean protein material of the present invention refers to a protein material derived from soybean protein and having low solubility in water. Preferably, the poorly soluble soybean protein material has a Nitrogen Solubility Index (NSI), described later, ranging from 10 to 60%. More preferably, the NSI is from 20 to 50%. Furthermore, the poorly soluble soybean protein material has a TCA solubilization rate, described later, of preferably 1 to 50%, and more preferably 10 to 45%. Moreover, the poorly soluble soybean protein material has a crude protein content of preferably 50 mass % or more, more preferably 60 mass % or more, and most preferably 65 mass % or more on a dry matter basis. The crude protein content referred to in the present invention is a crude protein mass obtained by multiplying a nitrogen amount measured using the Kjeldahl method by a nitrogen conversion factor of 6.25.

Typically, in a process of industrially producing peptides from soybean protein as a raw material, unhydrolyzed residue generated during decomposition of the soybean protein raw material by a protease is obtained as a precipitated fraction. Since peptides, which are the main product, belong to the low molecular weight fraction, this precipitated fraction is, in some cases, referred to as “HMF” (High Molecular Weight Fraction), which means the high molecular weight fraction. The production method will be explained below with examples.

### Soybean Protein Raw Material

The soybean protein raw material is obtained by concentrating protein from soybeans as the raw material, and examples thereof include soybean protein concentrate and soybean protein isolate. The soybean protein raw material may be sterilized and dried. The soybean protein raw material preferably contains 80 mass % or more of crude protein on a dry mass basis, and the soybean protein isolate is preferred.

The soybean protein isolate is generally prepared by the following method. That is, water is added to defatted soybeans, extraction is performed around neutral pH, and soy pulp is separated to obtain soy milk. Next, the soy milk is adjusted to around pH 4.5, and an isoelectric precipitate is collected. Water and an alkaline agent are added to the precipitate to obtain an aqueous solution with solids concentration ranging from 5 to 15 mass % and a pH of 5.7 to 8.0, preferably around pH of 6.8 to 7.5. The soybean protein isolate thus obtained may be used as a solution as it is in the subsequent steps, or may be used after adding water to the soybean protein isolate powder that has been subjected to a drying treatment. The soybean protein isolate is not limited to those obtained by the above production method, and may be produced by various modifications of such a production method. Examples of commercially available soybean proteins include “Fujipro-R” and “Fujipro-SE” (available from Fuji Oil Co., Ltd.).

### Hydrolysis

Hereinafter, an embodiment of producing a hydrolysate and a poorly soluble soybean protein material, which is a poorly soluble fraction, from a soybean protein raw material by an enzymatic hydrolysis method will be described.

The degree of enzymatic hydrolysis can be appropriately determined in consideration of the characteristics to be imparted to the peptides, which are the main products of the hydrolysis step. Generally, it is appropriate that not all molecules are hydrolyzed down to free amino acids, and a higher degree of hydrolysis is preferred. When setting the degree of hydrolysis based on the yield of the poorly soluble fraction, this yield is preferably from 20 to 35 mass %, and more preferably from 25 to 30 mass %. When setting based on the composition of a soluble fraction of the hydrolysis step, the content of a peptide fraction with a molecular weight of less than 500, based on the total amount of peptides and free amino acids, can be exemplified as preferably 50 mass % or more, more preferably 60 mass % or more, and even more preferably 65 mass % or more. The content of the peptide fraction with a molecular weight of less than 500 is measured as the molecular weight distribution described later.

The protease used for enzymatic hydrolysis to produce the soybean protein hydrolysate can be appropriately selected from proteases classified as “metalloproteases”, “acid proteases”, “thiol proteases”, or “serine proteases” in the classification of proteases, regardless of whether they are of animal, plant, or microbial origin, and preferably from proteases classified as “metalloproteases”, “thiol proteases”, or serine proteases.” Furthermore, a method of sequentially or simultaneously using two types or more, or three types or more enzymes belonging to different classifications is also efficient and preferred.

This classification of proteases is a classification method based on the type of amino acid at the active center, which is usually performed in the field of enzyme science.

Representative examples of the “metalloprotease” include Bacillus-derived neutral protease, Streptomyces-derived neutral protease, Aspergillus-derived neutral protease, and Thermoase, representative examples of the “acid protease” include pepsin, Aspergillus-derived acid protease, and Sumizyme FP, representative examples of the “thiol protease” include bromelain and papain, and representative examples of the “serine protease” include trypsin, chymotrypsin, subtilisin, Streptomyces-derived alkaline protease, Alcalase, and Bioprase.

The reaction pH and reaction temperature for the protease treatment are set according to the characteristics of the protease to be used, and usually, the reaction pH is preferably near the optimum pH, and the reaction temperature is preferably near the optimum temperature. Generally, the reaction temperature is from 20 to 80° C., preferably from 40 to 60° C. After the reaction, the reaction product is heated to a temperature sufficient to inactivate the enzyme (about 60 to 170° C.) to deactivate residual enzyme activity.

### Separation and Drying

The poorly soluble fraction, which is the unhydrolyzed residue generated by hydrolysis, is collected from the reaction solution after the protease treatment by centrifugation or filtration to obtain the poorly soluble soybean protein material. The collected poorly soluble soybean protein material is usually sterilized and then utilized in the form of a dried powder obtained by spray drying, freeze drying, or the like. Sterilization is preferably heat sterilization, and the heating temperature is preferably from 110 to 170° C., more preferably from 130 to 170° C. The heating time is preferably from 3 to 20 seconds. The reaction solution may also be adjusted to a certain pH. Micronization treatment such as wet grinding before drying can also yield a material with better texture.

### Characteristics of Poorly Soluble Soybean Protein Material

The poorly soluble soybean protein material obtained by the process exemplified above contains Group A saponins and DDMP saponins, preferably at 2.5 mass % or more, more preferably at 3 mass % or more, on a dry matter basis, of the poorly soluble soybean protein material. A major characteristic of this material is that, despite being a material with saponins at a high content, it does not cause flavor deterioration upon ingestion.

### Method for Measuring Nitrogen Solubility Index

The Nitrogen Solubility Index (NSI) is measured as follows. To 3 g of protein material sample, 60 mL of water is added and stirred with a propeller at 37° C. for 1 hour, then centrifuged at 1,400×g for 10 minutes to collect a supernatant (I). Next, 100 mL of water is added again to the remaining precipitate, and the mixture is stirred again with a propeller at 37° C. for 1 hour and then centrifuged to collect a supernatant (II). The supernatants (I) and (II) are combined, and water is added to the mixed liquid to obtain a volume of 250 mL. After the mixed liquid is filtered with filter paper (No. 5), a nitrogen content of the filtrate is measured by the Kjeldahl method. At the same time, the nitrogen amount in the sample is measured by the Kjeldahl method, and the proportion of the amount of nitrogen collected as the filtrate (water-soluble nitrogen) to the total amount of nitrogen in the sample is expressed in mass % and is defined as the NSI. Basically, the value is obtained by rounding off the value to the first decimal place.

### TCA Solubilization Rate

To a 2 mass % aqueous solution of a protein material, 0.44 M trichloroacetic acid (TCA) is added in an equal amount to prepare a 0.22 M TCA solution, and a TCA solubilization rate is a value obtained by measuring the ratio of soluble nitrogen by the Kjeldahl method. Basically, the value is obtained by rounding off the value to the first decimal place.

### Molecular Weight Distribution

Regarding a method for quantifying the peptide fraction with a molecular weight of less than 500 among peptides and free amino acids, the following is exemplified as a method for measuring molecular weight distribution.

The hydrolyzate is adjusted to a concentration of 0.1 mass % on a dry matter basis with an eluent, and filtered through a 0.2 μm filter to obtain the sample solution. A gel filtration system is assembled with two types of columns connected in series. First, known proteins and the like used as molecular weight markers are charged, and a calibration curve from a relationship between a molecular weight and a retention time is determined. Next, the sample solution is charged, and the content rate (%) of each molecular weight fraction is determined by the rate of the area of a specific molecular weight range (time range) in the area of the total absorbance chart (1st column: “TSK gel G3000SWXL” (Sigma-Aldrich), 2nd column: “TSK gel G2000SWXL” (Sigma-Aldrich), eluent: 1% SDS+1.17% NaCl+50 mM phosphate buffer (pH 7.0), 23° C., flow rate: 0.4 mL/min, detection: UV 220 nm). Basically, the value is obtained by rounding off the value to the first decimal place.

It should be noted that the following markers are used. Thyroglobulin, molecular weight: 335000; γ-globulin, molecular weight: 150000; Albumin, molecular weight: 67000; Peroxidase, molecular weight: 43000; Myoglobin, molecular weight: 18000; Cytochrome C, molecular weight: 12,384; Insulin, molecular weight: 5,734; Glutathione, molecular weight: 307; p-aminobenzoic acid, molecular weight: 137.

### Method for Preparing Chocolates

The chocolates of the present invention are characterized by adding 7 to 20 mass % of the poorly soluble soybean protein material into the dough. Preferably, the added amount is from 9 to 16 mass %, and more preferably from 10 to 14 mass %. Although the poorly soluble soybean protein material has saponins at a high content, good flavor quality can be maintained even when blended into chocolates in this manner. Particularly within the range of 7 to 20 mass %, the required amount of saponins can be ingested through ingestion of a realistic amount of chocolates, while maintaining flavor and physical properties that are acceptable for chocolates.

The method for preparing chocolates will be explained.

Known methods can basically be adopted for the preparation of chocolates. That is, sugars, cacao masses, and optionally oils and/or fats and other raw materials are mixed, and then micronized (refined) using a roller or the like to prepare a chocolate raw material. Before or after preparation, the poorly soluble soybean protein material and the like are added and mixed to form a chocolate dough. Thereafter, the chocolate dough is heated and kneaded, optionally molded, and then solidified, whereby the chocolates can be prepared. As another method, to a melted pre-prepared chocolate dough, the poorly soluble soybean protein material and the like are added and mixed, optionally molded, and then solidified, whereby the chocolates can be prepared. In any method, the poorly soluble soybean protein material to be added is a product in a powdered state obtained by powder drying or the like, or a product in a very easily disintegrating state obtained by freeze drying or the like. Preferably, by further actively micronizing these using a roller or the like, the grittiness of the chocolates can be reduced and the texture can be improved.

### EXAMPLES

Hereinafter, the present invention will be explained by way of examples, but the present invention is not limited thereto.

### Production Example 1: Preparation of Poorly Soluble Soybean Protein Material

To a 10 mass % aqueous solution of a soybean protein isolate (“Fujipro-R”, available from Fuji Oil Co., Ltd.), 0.2 mass % of a protease (“Protin SD-AY10”, available from Amano Enzyme Inc.) was added, and an enzymatic hydrolysis reaction was carried out at 50° C. for 5 hours. After the reaction, the resultant mixture was heated at 100° C. for 5 minutes to inactivate the enzyme, and then cooled to room temperature. After centrifugation at 8000 G for 10 minutes, the resultant precipitate was collected to obtain a poorly soluble fraction (HMF), which is a poorly digestible and poorly soluble soybean protein material. The resultant HMF was freeze-dried and then used in subsequent steps. The yield of the poorly soluble fraction was 28 mass %, the crude protein mass was 70.8 mass % on a dry matter basis, and a fraction with a molecular weight of less than 500 in a soluble fraction (peptides and free amino acids) was 65.4%.

### Measurement of Saponin Content

2 g of a test sample was subjected to heating reflux extraction twice with 100 mL of methanol, and then filtered through No. 5B filter paper to obtain a solution, which was afterwards adjusted to a volume of 250 mL. Approximately 3 mL of the resultant solution was dried to dryness, heated under reflux with 4 mL of 10% methanolic hydrochloric acid for 1 hour, and then cooled. Thereto was added 30 mL of water, 40 mL of ethyl acetate, and 1 mL of an internal standard substance (cholesteryl caprylate-ethyl acetate solution 1 mg/mL). After stirring, into the upper phase, 5 mL of saturated sodium bicarbonate solution was added twice and 10 mL of water was added twice, and then the liquid was dehydrated and dried to dryness. 2 mL of ethyl acetate was again added thereinto, a 1 mL aliquot was dried to dryness, and then 200 μL of pyridine and 200 μL of BSTFA [N,O-bis(trimethylsilyl)trifluoroacetamide] were added thereinto, held at 50° C. for 20 minutes. After cooling, to the resultant mixture, 4 mL of ethyl acetate was added, and the resultant liquid was subjected to gas chromatography. Soyasapogenol A and soyasapogenol B were used as standard substances, and the total value was defined as the amount of soybean saponins. The results are listed in Table 1.

### Analysis Conditions for GLC

Detector: FID
Column: DB-1 (J&W SCIENTIFIC) Fused silica 0.53 mm×30 m, film thickness 1.5 μm
Temperature: Sample injection port and detector 320° C.
Column 200° C. (held for 2 min)→20° C./min→300° C. (held for 48 min)
Carrier gas: Helium 100 kPa, Hydrogen 60 kPa, Air 50 kPa

Table 1 shows the analysis values of various soybean samples, including the poorly soluble soybean protein material (HMF). When compared with a commercially available soybean protein isolate (“Fujipro-R”, available from Fuji Oil Co., Ltd.), soybean peptide (“Hinute AM”, available from Fuji Oil Co., Ltd.), and commercially available Koya-tofu (available from Misuzu Corporation), it became clear that the saponin content of HMF was condensed at high concentration, which is three times that of a normal soybean protein isolate material.

TABLE 1
Saponin content in various soybean samples
(mass % on a dry matter basis)

| | Content (mass %) | Analysis value (%) | |
|---|---|---|---|
| | Saponin | NSI | TCA |
| Poorly soluble soybean protein | 3.1 | 48.9 | 32.5 |
| Soybean protein isolate | 0.95 | 81.2 | 3.2 |
| Soybean peptide | 0.25 | — | — |
| Koya-tofu | 0.35 | — | — |

### Example 1: Preparation of Saponin-Enriched Chocolates

1. According to the formulation in Table 2, 88 parts by mass of a chocolate raw material (“Milk Chocolate”, available from Fuji Oil Co., Ltd.) was heated to 50 to 53° C. to dissolve.
2. 12 parts by mass of a poorly soluble soybean protein material (HMF) was added and mixed.
3. After tempering, the resultant mixture was solidified at 4° C.
4. The solidified mixture was left in a room at 20 to 22° C. for 3 hours to obtain chocolate.

Since the poorly soluble soybean protein material (HMF) contains 3.10 mass % of soybean saponins, the chocolate (Example 1) contains 0.372 mass % of soybean saponins (372 mg per 100 g). Approximately 200 mg of soybean saponins can be ingested by consuming 50 to 60 g, which is equivalent to one typical chocolate bar.

### Comparative Examples 1 to 4

The preparation of a chocolate containing 0.372 mass % of soybean saponins was investigated, in which a soybean protein isolate (“Fujipro-R”), soybean peptide (“Hinute AM”), and Koya-tofu (available from Misuzu Corporation) were used as soybean samples. However, to achieve this, 39 mass % of the soybean protein isolate, or over 100 mass % of soybean peptide or Koya-tofu need to be blended into the chocolates, none of which are practical.

Therefore, the amount of these samples added was set to 12 mass %, which is the same as that of the poorly soluble soybean protein material (HMF) (Example 1), and additionally, to compensate for the insufficient saponins, a concentrated saponin material (“Soybean Saponin 80”, available from FAP Japan Co., Ltd., saponin content 80.0 mass %) was further added to create formulations that achieve 0.372 mass % (Comparative Examples 1 to 4). Koya-tofu was added after being powdered using a mixer. Additionally, chocolate dough without any soybean sample was prepared as a control and denoted as Reference Example 1. These formulations are shown in the upper part of Table 2.

TABLE 2
Formulations of chocolates and evaluation results

| | | Reference | | Comparative | Comparative | Comparative | Comparative |
|---|---|---|---|---|---|---|---|
| | | Example 1 | Example 1 | Example 1 | Example 2 | Example 3 | Example 4 |
| Formulation (g) | Chocolate raw material | 100 | 88 | 88 | 88 | 88 | 88 |
| | Poorly soluble soybean protein material | — | 12 | — | — | — | — |
| | Soybean protein isolate | — | — | 12 | — | — | — |
| | Soybean peptide | — | — | — | 12 | — | — |
| | Koya-tofu | — | — | — | — | 12 | — |
| | Concentrated saponin material (mg) | — | — | 323 | 428 | 413 | 465 |
| Saponin content | Sample-derived | — | 372 | 114 | 30 | 42 | — |
| (mg) | Concentrated saponin-derived | — | — | 258 | 342 | 330 | 372 |
| | Final saponin content | — | 372 | 372 | 372 | 372 | 372 |
| Flavor | Bitterness | 5 | 4.25 | 3.75 | 3 | 3.75 | 3 |
| evaluation | Astringency | 5 | 4.25 | 4 | 3.25 | 3.25 | 2.5 |
| | Chocolate flavor | 5 | 3.5 | 3 | 1.75 | 3 | 3.25 |
| | Mouth-melting property | 5 | 3.25 | 2.75 | 2.5 | 2.75 | 5 |

### Evaluation

The respective resultant samples of chocolates were subjected to sensory evaluation for the items indicated below. The evaluation was conducted by eight selected panelists sufficiently trained in the sensory evaluation of chocolate. The panelists tasted each sample under blind conditions and scored the items indicated below. The results shown are the averages of these scores. The sample with scores of 3 points or higher for all items was considered a pass.
Bitterness
5 points: it possesses the favorable bitterness inherent to chocolate
4 points: it possesses a slight bitterness that feels unnatural for chocolate
3 points: it possesses bitterness that feels unnatural for chocolate
2 points: it possesses a lingering bitterness that feels unnatural for chocolate
1 point: it possesses a strong, lingering bitterness that feels unnatural for chocolate
Astringency
5 points: No astringency
4 points: Almost no astringency
3 points: Slight astringency
2 points: Unpleasant astringency
1 point: Pungent astringency
Chocolate flavor
5 points: Very good chocolate flavor
4 points: Good chocolate flavor
3 points: Fairly good chocolate flavor
2 points: Somewhat lacking in chocolate flavor
1 point: Lacking in chocolate flavor
Mouth-melting property
5 points: Very good mouth-melting property
4 points: Good mouth-melting property
3 points: Fairly good mouth-melting property
2 points: Somewhat poor mouth-melting property
1 point: Poor mouth-melting property

The results are listed in the lower part of Table 2.

Example 1, although not reaching the level of Reference Example 1 (control) to which no sample was added, passed all sensory evaluation items. In contrast, when the soybean protein isolate was used, the amount of saponins could not be met with this sample alone. Comparative Example 1, in which 12 mass % of the soybean protein isolate was added and the insufficient saponins were supplemented with concentrated saponins, shows a tendency for the mouth-melting property to deteriorate, and bitterness, astringency, and chocolate flavor to decrease. Comparative Example 2, in which peptide and concentrated saponins were used in combination, exhibited particularly deteriorated flavor in addition to the deteriorated mouth-melting property, and Comparative Example 3, in which Koya-tofu and concentrated saponins were used in combination, exhibited the deteriorated mouth-melting property. Comparative Example 4, in which only concentrated saponins were used, exhibited particularly unpleasant astringency. As described above, only Example 1, in which the poorly soluble soybean protein material was used, contained a sufficient amount of saponins while minimizing the deterioration of flavor and physical properties.

### INDUSTRIAL APPLICABILITY

According to the present invention, saponins can be easily ingested. Furthermore, it is possible to achieve the wide distribution of saponin-enriched foods and beverages.

1. Chocolates containing from 7 to 20 mass % of a poorly soluble soybean protein material.

2. The chocolates according to claim 1, wherein the poorly soluble soybean protein material is unhydrolyzed residue generated by enzymatic hydrolysis of a soybean protein raw material.

3. The chocolates according to claim 1, wherein the poorly soluble soybean protein material contains 2.5 mass % or more of soybean saponins on a dry matter basis and has an NSI of 10 to 60%.

4. The chocolates according to claim 2, wherein the poorly soluble soybean protein material contains 2.5 mass % or more of soybean saponins on a dry matter basis and has an NSI of 10 to 60%.

5. A method for producing chocolates, the method comprising the following steps (A) to (C):
(A) enzymatically hydrolyzing a soybean protein raw material and collecting generated unhydrolyzed residue;
(B) drying the collected fraction to obtain a poorly soluble soybean protein material; and
(C) preparing a chocolate dough containing the poorly soluble soybean protein material, optionally molding the chocolate dough, and then solidifying the molded chocolate dough.

6. The method for producing chocolates according to claim 5, comprising adding the poorly soluble soybean protein material such that a content of the poorly soluble soybean protein material in the dough is from 7 to 20 mass %.

7. A method for producing a food material for supplying saponins, the method comprising the following steps (A) and (B):
(A) enzymatically hydrolyzing a soybean protein raw material and collecting generated unhydrolyzed residue; and
(B) drying the collected fraction to obtain a poorly soluble soybean protein material, which is a food material for supplying saponins.
